(19) United States
(12) Patent Application Publication
(10) Pub. No.: US 2004/0141002 A1
(43) Pub. Date: Jul. 22, 2004

(54) Method for processing data in a web page

(75) Inventors: Ding Lien Chun, Taoyuan (TW); Lee Ching Kang, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: EC-Server com., Inc., Taipei (TW)

(21) Appl. No.: 10/428,739

(22) Filed: May 2, 2003

(30) Foreign Application Priority Data
Jan. 17, 2003 (TW) 92101054

(51) Int. Cl. G09G 5/00

(52) U.S. Cl. 345/738

(57) ABSTRACT

A method for processing data in a web page is provided. The method comprises: (a) providing said web page with a new data; (b) storing said new data in a database; (c) providing plural functional icons displayed in a frame; (d) selecting one of said plural functional icons to be a first executing icon; and (e) processing said new data in response to a respective click of said first executing icon. Most importantly, these operation can be displayed in the same interface.

### FIELD OF THE INVENTION

The present invention relates to a method for new-adding, searching, amending and deleting, and more particularly to a method for new-adding, searching, amending and deleting in the same interface.

### BACKGROUND OF THE INVENTION

In the early days, the data is saved as files and controlled by the self computer formula to release, add, amend and search. The database is not considered. Until the database is developed, the management and operation of the data can be executed by the database system. Therefore, the general application system only needs to call the service provided by the database and then more advantages will be gained. Since then the database system is not merely a part of program, but has become a flat and a frame for developing the application system. The list service is the same as the database system because the operation of each application system has changed from a respective application system to an unified service.

The four basic operation of data are addition, search, amendment and deletion. In the traditional operating system, the four operation are respectively independent modes, the users have to complete the corresponding functions in the different interfaces. Thus, it is necessary to open the reduplicate windows. In such a way, not only it is inconvenient when using the application system but also the memory of the computer will be improperly occupied. Therefore, the present invention takes the addition, search, amendment and deletion together as the functional integration of the data processing and all the operations are in the same interface. This is simpler and more convenient while using these operations.

### SUMMARY OF THE INVENTION

It is an object of the present invention to provide a method for processing data in a web page, comprising: (a) providing the web page with a new data; (b) storing the new data in a database; (c) providing plural functional icons displayed in a frame; (d) selecting one of the plural functional icons to be a first executing icon; and (e) processing the new data in response to a respective click of the first executing icon.

It is another object of the present invention to provide a method for adding, searching, amending and deleting the data in the same interface of the web page.

Preferably, the plural functional icons comprises a new-adding icon, a deleting icon, a searching icon and an amending icon.

Preferably, the step (e) further comprises steps: (f1) clicking the searching icon and obtaining a searching data from the database; (f2) selecting one of the plural functional icons to be a second executing icon; and (f3) processing the searching data in response to a respective click of the second executing icon.

Preferably, the step (e) further comprises steps: (g1) clicking the amending icon and obtaining an amending data desired; and (g2) selecting one of the plural functional icons to be a second executing icon; and (g3) processing the amending data in response to a respective click of the second executing icon.

Preferably, the step (b) is performed by means of clicking a new-adding icon.

It is another object of the present invention to provide an interface for processing data in a web page, comprising plural functional icons to be displayed in a frame for processing a desired data in a specific sequence wherein the specific sequence is defined by a sequence of clicking at least one of the plural functional icons.

Preferably, the plural functional icons comprises a new-adding icon, a searching icon, an amending icon and a deleting icon.

Preferably, the desired data is a desired searching data while the searching icon is clicked first.

Preferably, the desired data is a desired amending data while the amending icon is clicked first.

Preferably, the desired data is stored in a database.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a flow chart in accordance with a embodiment of the present invention.

FIG. 2 is a diagram showing the operation of a web page according to a embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only It is not intended to be exhaustive or to be limited to the precise form disclosed.

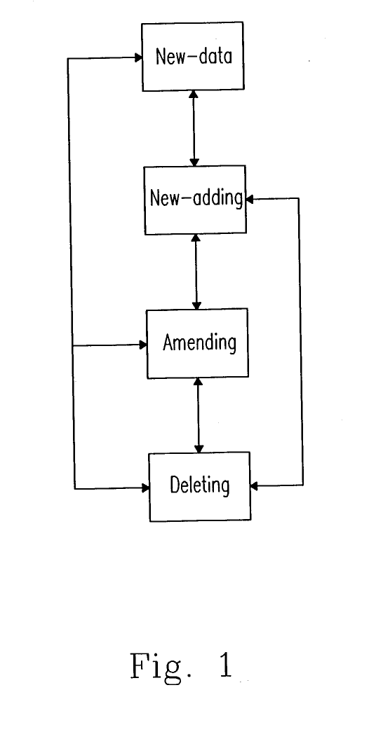

Please refer to FIG. 1, that is the operation flow chart of the preferred embodiment in the present invention. The operation steps are applied to a web page. First, a new data in the web page is provided and then the new data will be saved in a database. Afterwards the user can click one of the searching icon, the amending icon and the deleting icon to decide the executed function for the new data. 1. If one clicks the searching icon and keys in the searching key word, then the searching data will be obtained. Next, one can continuously clicks other icons if the data needs to be executed other functions (ex. Clicking the adding icon if the processed data needs to be saved). 2. If one clicks the amending icon, the data can be amended directly. Next, one can continuously clicks other icons if the data needs to be executed other functions (ex. Clicking the adding icon if the processed data needs to be saved). 3. If one clicks the deleting icon, the data will be deleted directly.

Formerly, the four basic operations for data maintenance are new-addition, search, amendment and deletion which are respectively independent modes. The user has to complete the corresponding function in the different interfaces. It is very tedious and annoying for the user when operating the application system. Thus, the preferred embodiment of the present invention is that all of the operations including new-addition, search, amendment and deletion are unified into one functional integration and can be completed in the same interface. New-addition means that the data are keyed in for the first time. Amendment means that the data need to be changed after new-addition. Search means that the data can be cross-searched and obtained within any column. The undesired data can be became nullified or deleted directly.

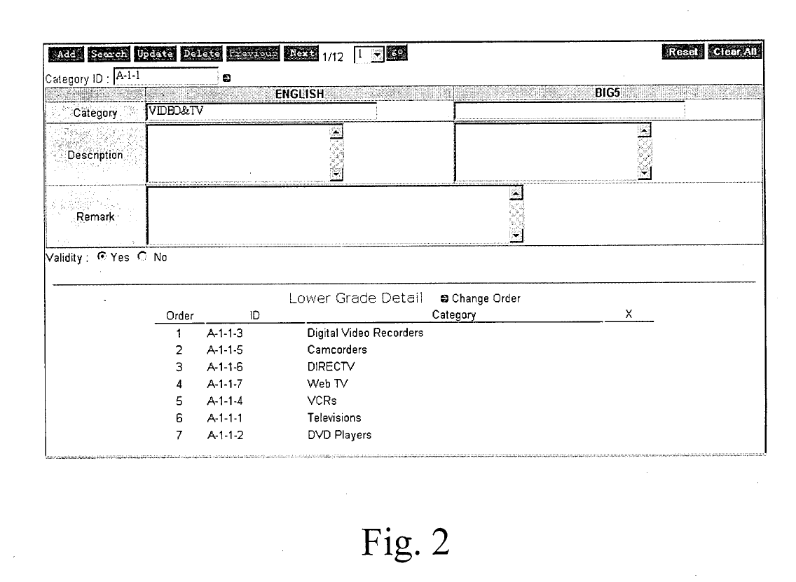

As shown in FIG. 2, all the columns shown in the frame are not only the key-in columns for the data maintenance but also the columns for being searched with the key word. The key point of the above-mentioned technique is to take the four basic operations as one integration. The practical operation is as following:

In the tool column, the new-addition, search, amendment and deletion functions are unified one integration, which is very convenient for the user. When the user needs to release the new message, all he has to do is follow the indication and key in the content. There are many additional functions for the users needs such as the different display forms: (1) the detailed description in HTML form; (2) the detailed description in pure text form. The user can also define some functions with more detailed description in this page, upload pictures and explain the pictures with words, which is one of the auxiliary functions. After establishing the detailed data, expect the data classifying and the recommendatory classifying columns, all other columns can be the columns for being searched with the key word. The last step of establishing the detailed data is clicking the new-adding icon to save the data. If the data appear wrong statistics or expired information, the user only needs to search this data and correct it, then click the amending icon. The operation of deletion is the same. Therefore, the present invention provides an excellence method for managing the data with high accuracy, time-efficiency and gradation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for processing data in a web page, comprising:
(a) providing said web page with a new data;
(b) storing said new data in a database;
(c) providing plural functional icons displayed in a frame;
(d) selecting one of said plural functional icons to be a first executing icon; and
(e) processing said new data in response to a respective click of said first executing icon.

2. The method according to claim 1, wherein said plural functional icons comprises a new-adding icon, a deleting icon, a searching icon and an amending icon.

3. The method according to claim 2, wherein said step (e) further comprises steps:
(f1) clicking said searching icon and obtaining a searching data from said database;
(f2) selecting one of said plural functional icons to be a second executing icon; and
(f3) processing said searching data in response to a respective click of said second executing icon.

4. The method according to claim 2, wherein said step (e) further comprises steps:
(g1) clicking said amending icon and obtaining an amending data desired; and
(g2) selecting one of said plural functional icons to be a second executing icon; and
(g3) processing said amending data in response to a respective click of said second executing icon.

5. The method according to claim 1, wherein said step (b) is performed by means of clicking a new-adding icon.

6. An interface for processing data in a web page, comprising plural functional icons to be displayed in a frame for processing a desired data in a specific sequence wherein said specific sequence is defined by a sequence of clicking at least one of said plural functional icons.

7. The interface according to claim 6, wherein said plural functional icons comprises a new-adding icon, a searching icon, an amending icon and a deleting icon.

8. The interface according to claim 6, wherein said desired data is a desired searching data while said searching icon is clicked first.

9. The interface according to claim 6, wherein said desired data is a desired amending data while said amending icon is clicked first.

10. The interface according to claim 6, wherein said desired data is stored in a database.
